(19) United States
(12) Patent Application Publication
(10) Pub. No.: US 2014/0280728 A1
(43) Pub. Date: Sep. 18, 2014

(54) SYSTEM AND METHOD FOR COMMUNICATING WITH MUSIC CLIPS

(71) Applicants: Bryan Szerlip Joyce, Chester, NJ (US); Michael Joyce, JR., Chester, NJ (US)

(72) Inventors: Bryan Szerlip Joyce, Chester, NJ (US); Michael Joyce, JR., Chester, NJ (US)

(21) Appl. No.: 14/213,422

(22) Filed: Mar. 14, 2014

Related U.S. Application Data
(60) Provisional application No. 61/793,052, filed on Mar. 15, 2013.

(51) Int. Cl. H04L 12/58

(52) U.S. Cl. CPC H04L 51/10; H04L 51/08
USPC 709/217

(57) ABSTRACT

A system for users to communicate with other users through music clips is provided. A clip management module receives from a user a selection of a music clip, which is a segment of a musical piece that conveys the emotion or thought of the user. A communication module receives from the user at least one recipient and transmits the selected music clip to the recipient. The recipient can respond by sending a music clip to the user thereby creating a musical conversation.

### CROSS REFERENCE TO RELATED APPLICATION

This application claims the benefit of priority under 35 U.S.C. Section 119(e) to U.S. Provisional Application Ser. No. 61/793,052, filed Mar. 15, 2013, which is incorporated herein by reference.

### BACKGROUND OF THE INVENTION

Social networking websites such as facebook and google+ enable users to communicate with each other using text messages and to share links to music and videos. Often, there are many situations in which a user would like to convey to another a very well defined message with music or music video. For example, a user may wish to express his everlasting love for someone with a song that precisely captures his mood or emotion.

However, simply providing a link to a complete musical piece may not necessarily capture his thoughts or emotion precisely as the piece may include many different rhythms and lyrics. Therefore, what is needed is a new way to enhance user communication and interaction that allows users to more precisely convey their thoughts and emotions with music.

### BRIEF DESCRIPTION OF THE DISCLOSURE

According to one embodiment of the present invention, a system for users to communicate with other users through music clips is provided. The system includes a processor, and clip and communication modules executable by the processor. The clip module is operable to receive from a user a selection of a music clip, in which the music clip is defined as a segment of a musical piece. The clip typically represents the emotion or thought of the user. The communication module is operable to receive from the user at least one recipient and to transmit the selected music clip to the recipient. In response, the recipient can send back its own music clip so as to start a musical conversation.

In another embodiment of the present invention, a database storing music data regarding a plurality of musical pieces and searchable by emotion categories is provided.

In yet another embodiment of the present invention, a computer-implemented method for users to communicate with other users through music clips is provided. The method involves receiving from a user a selection of a music clip through a computer network, in which the music clip is defined as a segment of a musical piece. Also received from the user is at least one recipient through the computer network. Then, the selected music clip is transmitted to the recipient.

### BRIEF DESCRIPTION OF THE DRAWINGS

FIG. 1 illustrates a general computing environment for providing a system for communicating with music clips according to the present invention.

FIG. 2 is a block diagram of an exemplary system for communicating with music clips according to the present invention.

FIG. 3 is a flow diagram illustrating a two user communication according to the present invention.

FIG. 4 is a flow diagram illustrating a multi-user communication according to the present invention.

FIG. 5 is a screen shot illustrating a music search according to the present invention.

FIG. 6 is a screen shot illustrating a message containing a music clip according to the present invention.

### DETAILED DESCRIPTION OF THE INVENTION

For purposes of the present application, a music clip means a segment of a complete musical piece, which has been extracted. The music clip can be audio, video or both, and can be in any storage format including mp3, mp4, wmv, way, 3g2, aac, aif, avi, m1v and the like. Also for purposes of the present application, the terms “code”, “program”, “application”, “software code”, “software module”, “module” and “software program” are used interchangeably to mean software instructions that are executable by a processor.

FIG. 1 illustrates a general computing environment for providing a system 12 for users to communicate with not just text, but also with music clips. An exemplary system 12 can be a social networking system that allows users to communicate with each other and share photo, audio and video files.

The system 12 is connected to a computer network 4 such as the Internet through a communication link 6 and interacts with computing devices (8,10,11) of users. The computing devices of users can be any computer capable of communicating with a computer network such as a notebook computers, desktop computers, smart phones such as an Apple iPhone and Google Android devices, tablets and the like.

Under the computing environment of FIG. 1, any user can create music clips and send it to any other user by email or SMS, for example. The recipient of the music clip can then respond with a music clip of his own. The system 12 also allows the users to post the music clips to their own message board or other social networking websites such as facebook 3. This way, the system 12 not only provides a traditional method of communication using texts, but it also enhance user communication and interaction in a fun way by allowing them to more precisely convey their thoughts and emotions with music clips.

Referring now to FIG. 2, the system 12 of the present invention centrally manages electronic communications and music clips that have been created by users. The system 12 includes a multitasking, real-time software technology that can concurrently handle multiple users.

The system 12 is connected to the communication link 6 through an I/O interface 22, which receives information from and sends information over the communication link 6 to the computers (8,10,11) of various users. The system 12 of FIG. 2 includes dynamic memory storage 24 (e.g., DRAM), processor (CPU) 26, program storage 28, I/O device 24 such as a keyboard and mouse and a database 30, all commonly connected to each other through a bus 32. The program storage 28 stores, among others, a clip management module 34 and a communication module 36. The clip management module 34 allows users to extract and create their own clips from a library of musical pieces that are stored in the database 30. Alternatively, the module 34 also allows users to select music clips from a library of music clips already stored in the database 30. The communication module 36 receives recipients from the users and transmits the selected music clip to the recipients.

Any of the software programs in the program storage 28 is transferred to the memory 24 as needed and is executed by the CPU 26. The system 12 can be any computer such as a personal computer, minicomputer, workstation or mainframe, or a combination thereof. While the system 12 is shown, for illustration purposes, as a single computer unit, the system may comprise a group/farm of computers which can be scaled depending on the processing load and database size.

Like the system 12, the user devices (8,10,11) can be identical in terms of the electrical components and typically include a touch screen as an additional I/O device. For interaction with the clip module 34 and communication module 36 in the system, a user device can do so through a browser or it can have a downloadable user interface module (e.g., an app) that can be run by its own processor. In that case, the app runs a portion of the clip module 34 and communication module 36 for interaction with the system 12.

There are several ways that a user 8 can create a music clip. One way is to record his own music clip by recording live music or sounds. Another way is to listen to a musical piece in his computing device 8, which can be automatically recognized by the app. Once the piece is selected, the user can then extract or cut out any portion to create the clip.

Another way is for the user to search a library of songs or music clips stored in the database 30. The system 12 tracks in its database 30 such data as top shared songs, top artists, top clips, top albums and the like. Accordingly, the user 8 can search the database 30 by lyric containing specific words, genre, emotion category, artist, top music clips sent by others and previewing them, system's own suggestions, record label, year, top songs in a specific time frame, album name, new releases, favorites by others, what other users have posted and the like.

The database 30 of the system 12 stores and tracks all clips shared by users and are accessible and searchable by the users.

Of particular significance is the system's ability to search for an emotion category. An emotion category can be any category that conveys a user's feeling. Examples of emotion categories can be happy, dance, upbeat, sad, break-up, love and the like. The system 12 can provide predetermined emotion labels/category for the user to select. FIG. 5 shows a screen shot of a search of songs by an emotion category of “Love”.

Once the song is selected, the user 8 interacts with the clip management module 34 to create a clip from the selected song. Next, the user 8 selects recipients of the music clip. The user 8 can select anyone in the contacts list of the user's computing device or input any phone number or email address as the recipients. The user 8 has the option of public or private multi-user send using the copying and blind copying functions (bcc/cc).

The communication module 36, whether running in the user's computing device 8 as an app or in the system 12, can also link directly to social media websites such as facebook, twitter, google+ and others, and allows users to sign in with social media logins. The communication module 36 can also link directly with other apps and websites to assist in transmitting the music clip for posting. Thus, the recipient can be the system's own social media website or other social media websites.

When another user 10 receives a clip from user 8, that user will be able to listen to the clip and then respond to “resend” the clip to other users assuming that the user 10 is registered with the system 12. Otherwise, the user 10 will be able to listen to the clip, and at the end will be prompted to register in order to download an app for that user to be able to send their own clip, respond or share the clip that user 8 sent him. FIG. 6 shows a screen shot of a message received by a recipient. The message includes a short 10 second music clip (as shown by the time icon) from the song “I Love It” by Icona Pop along with a text of “Love this song . . . ”.

For the music clip, all recipients will see a time bar, title, artist, year produced, record label, genre, information on who sent the clip, and other information. The page playing the music clip will also have links to a store such as itunes store or google play store or an appropriate music download service.

All recipients will also see silent advertisements while the music clip is playing and while the recipient is using the app or interacting with the clip module 34. Non-registered users can see visual/audio advertisements before or after the clips. However, advertisers can send their own clips, which is either video or audio only.

Non-registered users will see prompts to download and sign up for the system 12.

FIG. 3 is a flow diagram illustrating a two-user communication according to the present invention. In the figure, user A is the creator of the music clip and transmits it to user B either with or without a message. Assuming that user B is registered with the system 12, user B then has a choice of responding with a new music clip of his own or modifying the clip from user A either with or without a message. Subsequently, users A and B can exchange further clips and messages with each other so as to hold a musical “conversation”.

FIG. 4 is a flow diagram illustrating a possible scenario in multi-user communication according to the present invention. Similar to FIG. A, user A is the creator of the music clip and transmits it to user B either with or without a message. User B responds by forwarding the music clip to user C with or without any modification to the clip. User C then forwards the clip to user D and responds to user B. User D then forwards the clip to user E who then forwards it to user C. User B who received a message from user C forwards the clip to users E and K. In this way, multiple users participate in a musical conversation.

The system 12 also offer clips recorded by celebrities, public figures, members of the media and the like, which can be shared by the users for free or for a fee per clip. They are stored as part of the database 30 which are accessible to all subscribers/registered users.

A user can also pair a photo or group of photos with a music clip and share it with other users. The system 12 also provides the capability for users to send e-cards with recordings to other users.

While the system 12 is described above with reference to music clips audio or video format, other types of media can also be shared through a similar method as music clips.

The above disclosure is intended to be illustrative and not exhaustive. This description will suggest many modifications, variations, and alternatives may be made by ordinary skill in this art without departing from the scope of the invention. Those familiar with the art may recognize other equivalents to the specific embodiments described herein. Accordingly, the scope of the invention is not limited to the foregoing specification.

What is claimed is:

1. A system for users to communicate with other users through music clips comprising:
a processor;
a clip module executable by the processor, the clip module operable to receive from a user a selection of a music clip, the music clip defined as a segment of a musical piece;
a communication module executable by the processor, the communication module operable to receive from the user at least one recipient and to transmit the selected music clip to the recipient.

2. The system of claim 1, wherein the communication module operable to transmit a user-specified photograph along with the music clip.

3. The system of claim 1, wherein the clip module creates a music clip by having the user listen to a musical piece containing the music clip.

4. The system of claim 1, wherein the clip module creates a music clip based on a user-specified search of musical pieces by one or more of a lyric, genre, emotion category and artist.

5. The system of claim 1, wherein the clip module creates the music clip based on a user-specified search of musical pieces by an emotion category.

6. The system of claim 1, wherein the clip module selects the music clip based on top shared music clips.

7. The system of claim 1, wherein the communication module is operable to transmit the music clip to a social media website.

8. The system of claim 1, wherein the communication module is linked with the social media website and allows the user to log in to the social media website.

9. The system of claim 1, wherein the communication module prompts the recipient to download a software for use in responding to the user.

10. The system of claim 1, wherein the communication module displays an advertisement on a display of the recipient while the music clip is played.

11. The system of claim 1, wherein the communication module plays back a video or audio clip as an advertisement on a display of the recipient.

12. The system of claim 1, wherein the communication module displays, on a display of the recipient, a link to a store for purchasing the musical piece associated with the music clip while the music clip is played.

13. The system of claim 1, wherein:
the clip module is operable to receive from the recipient a selection of a second music clip;
the communication module is operable to transmit the selected second music clip to the user as a response.

14. The system of claim 1, further comprising a database storing data regarding a plurality of musical pieces and being searchable by an emotion category.

15. The system of claim 1, wherein the clip module is adapted to:
send to the user music data associated with a particular emotion category from the database for selection of a musical piece; and
create the music clip from the selected musical piece.

16. A system for users to communicate with other users through music clips comprising:
a database storing music data regarding a plurality of musical pieces and searchable by emotion categories;
a processor;
a clip module executable by the processor, the clip module adapted to send to the user music data associated with a particular emotion category from the database for selection of a musical piece and to create a music clip from the selected musical piece, the music clip defined as a segment of a musical piece.

17. The system of claim 16, wherein:
the database is further adapted to be searchable by a lyric, genre and artist;
the clip module is further adapted to send to the user music data associated with a particular lyric from the database for selection of a musical piece and to create the music clip from the selected musical piece.

18. The system of claim 16, wherein the clip module selects the music clip based on top shared music clips.

19. The system of claim 16, wherein the communication module is operable to transmit the music clip to a social media website.

20. The system of claim 16, wherein the communication module is linked with the social media website and allows the user to log in to the social media website.

21. The system of claim 16, wherein the communication module displays an advertisement on a display of the recipient while the music clip is played.

22. The system of claim 16, wherein:
the clip module is operable to receive from the recipient a selection of a second music clip;
the communication module is operable to transmit the selected second music clip to the user as a response.

23. A computer-implemented method for users to communicate with other users through music clips comprising:
receiving from a user a selection of a music clip through a computer network, the music clip defined as a segment of a musical piece;
receiving from the user at least one recipient through the computer network; and
transmitting the selected music clip to the recipient.

24. The method of claim 23, wherein the step of transmitting includes transmitting a user-specified photograph along with the music clip.

25. The method of claim 23, further comprising creating a music clip by having the user listen to a musical piece containing the music clip.

26. The method of claim 23, further comprising creating a music clip based on a user-specified search of musical pieces by one or more of a lyric, genre, emotion category and artist.

27. The method of claim 23, further comprising creating a music clip based on a user-specified search of musical pieces by an emotion category.

28. The method of claim 23, wherein a clip management module running on a processor selects the music clip based on top shared music clips.

29. The method of claim 23, wherein a communication module running on a processor transmits the music clip to a social media website.

30. The method of claim 23, wherein a communication module running on a processor is linked with the social media website and allows the user to log in to the social media website.

31. The method of claim 23, wherein a communication module running on a processor prompts the recipient to download a software for use in responding to the user.

32. The method of claim 23, wherein a communication module running on a processor displays an advertisement on a display of the recipient while the music clip is played.

33. The method of claim 23, wherein a communication module running on a processor plays back a video or audio clip as an advertisement on a display of the recipient.

34. The method of claim 23, wherein a communication module running on a processor displays, on a display of the recipient, a link to a store for purchasing the musical piece associated with the music clip while the music clip is played.

35. The method of claim 23, further comprising:
receiving from the recipient a selection of a second music clip;
transmitting the selected second music clip to the user as a response.

36. The method of claim 23, further comprising searching a database of music data regarding a plurality of musical pieces by an emotion category.

37. The method of claim 23, further comprising:
sending to the user music data associated with a particular emotion category from a database for selection of a musical piece; and
creating the music clip from the selected musical piece.
